(19) United States
(12) Patent Application Publication
(10) Pub. No.: US 2013/0333118 A1
(43) Pub. Date: Dec. 19, 2013

(54) DUAL HEAD BREAKER BAR

(71) Applicant: Thorsen Tools, Inc., Ontario, CA (US)

(72) Inventor: DAVID MEHOLOVITCH, Glendora, CA (US)

(73) Assignee: Thorsen Tools, Inc., Ontario, CA (US)

(21) Appl. No.: 13/906,094

(22) Filed: May 30, 2013

Related U.S. Application Data
(60) Provisional application No. 61/653,022, filed on May 30, 2012.

(51) Int. Cl. B25F 1/00

(52) U.S. Cl. CPC B25F 1/00
USPC 7/138

(57) ABSTRACT

A hand tool includes a bar, a first head, and a second head. The first head is located at a first end of the bar and includes a curved surface and a flattened edge. The second head is located at a second end of the bar and includes at least one socket.

### CROSS-REFERENCE TO RELATED APPLICATIONS

This application claims benefit of U.S. provisional patent application Ser. No. 61/653,022, filed May 30, 2012, which is herein incorporated by reference.

### BACKGROUND OF THE INVENTION

1. Field of the Invention

Embodiments of the present invention generally relate to a hand tool that can perform multiple functions. More specifically, embodiments of the present invention relate to a hand tool that is both a pry bar and a breaker bar.

2. Description of the Related Art

A pry bar is a common tool that includes a bar with one end being curved with a flat tip and a second end being slightly curved also with a flat tip. The pry bar typically forms a lever such that when the flat tip of either end is inserted between two objects, and force is applied to the opposite end of the pry bar, the objects are forced, or pried, apart.

A breaker bar is a common tool that includes a bar with a socket at one end. The breaker bar is non-ratcheting and serves to loosen fasteners that have become frozen. For example, breaker bars are commonly used to change a tire by loosening tire bolts. In use, the socket of the breaker bar is mated with a fastener, and force is applied to an end opposite the socket. Such force imparts a large amount of torque to the socket, thereby loosening the fastener.

Commonly, pry bars and breaker bars may be required when two objects are both fastened and adhered together. In the case of changing a tire, for example, one may need to use a breaker bar to loosen the tire bolts, and may need a pry bar to loosen a hubcap away from the tire. When both types of tools are needed, it may be inconvenient to locate both types of tools or switch between two tools during a project. Therefore, there is a need for a tool that can act as both a pry bar and a breaker bar.

### SUMMARY OF THE INVENTION

The present invention generally relates to a hand tool, comprising a bar, a first head, and a second head. In one embodiment, the first head is located at a first end of the bar and includes a curved surface and a flattened edge. The second head is located at a second end of the bar and includes at least one socket. In one embodiment, the second head may include multiple sockets that are rotatably coupled at the second end of the bar.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a tool according to an embodiment of the present invention.

### DETAILED DESCRIPTION

The present invention relates to a hand tool that may act as both a pry bar and a breaker bar. The tool includes a bar, a first end that is slightly curved with a flat edge that may be used to pry objects apart, and a second end that includes at least one socket that may be used to loosen fasteners.

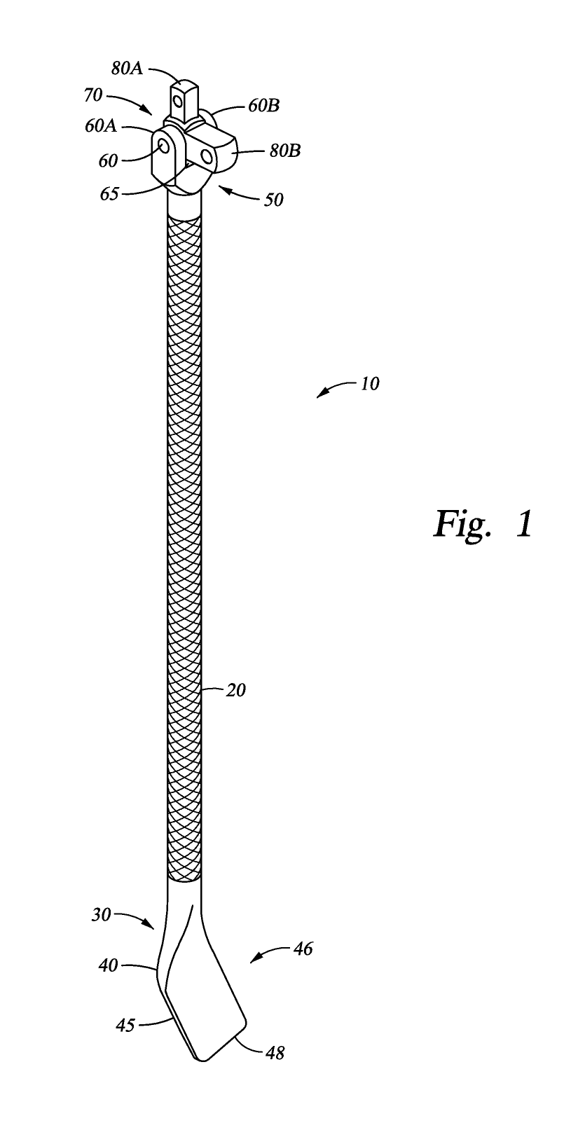

An embodiment of the tool 10 of the present invention is shown in FIG. 1. The tool 10 includes a bar 20, which may be made of a variety of materials such as metal and metal alloys. The bar 20 could comprise a solid material, or the bar could have a hollowed-out midsection. The bar 20 may be relatively straight. The tool also includes a first head 30 and a second head 50 that are connected to the bar 20 at opposite ends. The first head 30 or the second head 50 may be integrally formed with the bar 20, or the first head 30 or the second head 50 may be a separate component from the bar 20. The first and second heads 30, 50 are configured for different functions.

The first head 30, located at a first end of the tool 10, may include a curved portion 40 and a flattened edge 45. The curved portion 40 may include any angle relative to the straight bar 20, and in FIG. 1, the curved portion 40 includes a curvature of approximately 45 degrees relative to the bar 20. The flattened edge 45 may be located at an end 46 of the first head 30, and may include a taper stemming from the bar 20 to a tip 48 of the tool 10, for example, or a taper stemming from a point along the first head 30 to the tip of the tool 10. The flattened edge 45 may be a portion of the first head with a uniform thinner cross section positioned at the tip of the tool 10. The flattened edge 45 functions to allow the tool 10 to be wedged between two closely positioned objects. When force is applied at a second end of the tool 10 opposite to the first end of the tool 10, a lever is formed, and the two objects may be forced apart by the tool 10.

In one embodiment, the second head 50, located at the second end of the tool, may include a socket 80. The socket 80 may be integral to the second head 50, or may be removable to accommodate different diameter socket heads. When the socket 80 is positioned within a reciprocal fastener, such as a bolt, force may be applied at the first end 30 of the tool 10, which thereby results in a torque being applied to the fastener. The torque enables the connection of the fastener to be loosened.

In one embodiment, the second head 50 may form two parallel surfaces 60A, B with a channel 65 formed therebetween. The channel 65 may receive multiple sockets 80A, B that may be joined together, which are collectively rotatably coupled to a pivot point 60 in the second head 50. The two sockets 80A, B are coupled to the pivot point 60 by a pivot receiver assembly 70, which allow the sockets to lock into place. The pivot receiver assembly 70 may be a detent locking assembly. Each socket 80A, B may have different diameters. For example, the tool 10 shown in FIG. 2 includes a socket 80A with a ⅜″ head, and a second socket 80B with a ½″ head. Other alternate socket sizes and combinations of sockets are contemplated.

Accordingly, the tool 10 as disclosed may function as both a pry bar at a first end and a breaker bar at a second end, and a user need not switch between multiple tools for one project that requires both functions.

While the foregoing is directed to embodiments of the present invention, other and further embodiments of the invention may be devised without departing from the basic scope thereof, and the scope thereof is determined by the claims that follow.

1. A hand tool, comprising:
a bar;
a first head at a first end of the bar, the first head including a curved surface and a flattened edge; and
a second head at a second end of the bar, the second head including at least one socket.

2. The hand tool of claim 1, wherein the first and second heads are integral with the bar.

3. The hand tool of claim 1, wherein the first and second heads are removable components from the bar.

4. The hand tool of claim 1, wherein the second head includes more than one socket that rotatably couples to the second end of the bar.

5. The hand tool of claim 4, wherein each socket has a different diameter.

6. The hand tool of claim 4, wherein the second head includes two parallel surfaces with a channel formed therebetween, and the sockets rotate within the channel.

7. The hand tool of claim 6, wherein the sockets lock into position within the channel.

8. The hand tool of claim 7, wherein a detent assembly locks the sockets into position within the channel.

9. The hand tool of claim 1, wherein the flattened edge is positioned at a tip of the first end.

10. The hand tool of claim 1, wherein the flattened edge includes a taper.

11. A hand tool, comprising:
a substantially straight bar;
a first head integrally formed at a first end of the bar, the first head including an curved surface and a flattened edge at a tip of the first head; and
a second head integrally formed at a second end of the bar, the second head for receiving at least one socket.

12. The hand tool of claim 11, wherein the at least one socket is integrally formed within the second head.

13. The hand tool of claim 11, wherein the second head receives more than one socket that rotatably couples to the second head.

14. The hand tool of claim 13, wherein each socket has a different diameter.

15. The hand tool of claim 13, wherein the second head includes two parallel surfaces with a channel formed therebetween, and the sockets rotate within the channel.

16. The hand tool of claim 15, wherein the sockets lock into position within the channel.

17. The hand tool of claim 16, wherein the sockets are coupled together.

18. The hand tool of claim 16, wherein a detent assembly locks the sockets into position within the channel.

19. The hand tool of claim 11, wherein the flattened edge is positioned at a tip of the first end.

20. The hand tool of claim 11, wherein the flattened edge includes a taper.
